(19) United States
(12) Patent Application Publication
(10) Pub. No.: US 2001/0017486 A1
(43) Pub. Date: Aug. 30, 2001

(54) Nonreciprocal circuit device and communication apparatus incorporating same

(75) Inventor: Takahiro Yodo, Ishikawa-ken (JP)

Correspondence Address: OSTROLENK FABER GERB & SOFFEN, 1180 AVENUE OF THE AMERICAS, NEW YORK, NY, 100368403

(73) Assignee: Murata Manufacturing Co., Ltd.

(21) Appl. No.: 09/739,725

(22) Filed: Dec. 18, 2000

(30) Foreign Application Priority Data
Dec. 16, 1999 (JP) 11-357221

(51) Int. Cl. H02M 3/06

(52) U.S. Cl. 307/109

(57) ABSTRACT

A nonreciprocal circuit device having good characteristics capable of maintaining constantly stable and reliable connections even when a high temperature is applied, and a communication apparatus incorporating the nonreciprocal circuit device. The nonreciprocal circuit device can be made compact at a low cost and can obtain a large attenuation at a predetermined frequency band. In the nonreciprocal circuit device, an upper yoke is connected to a lower yoke, a bottom grounded part of a magnetic assembly is connected to the lower yoke. In addition, ports P1 and P2 of first and second central conductors, the hot-side electrodes of first and second capacitors, and input/output terminals are connected each other, and the port P3 of a third central electrode, the hot-side electrode of a third capacitor, and the hot-side electrode of a terminating resistor R are connected to each other. Furthermore, the cold-side electrodes of the first to third capacitors, the cold-side electrode of the terminating resistor R, and a ground terminal are connected to each other. A conductive adhesive is applied for these connections.

### BACKGROUND OF THE INVENTION

1. Field of the Invention

The present invention relates to nonreciprocal circuit devices such as isolators and circulators used in high frequency bands such as a microwave band, and communication apparatuses incorporating the nonreciprocal circuit devices.

2. Description of the Related Art

Lumped-constant isolators and circulators as nonreciprocal circuit devices have characteristics in which attenuation in a direction in which a signal is transmitted is extremely small, while attenuation in a reversed direction is extremely large. Thus, communication apparatuses such as mobile phones including the nonreciprocal circuit devices use such characteristics.

In the nonreciprocal circuit device described above, for example, in a magnetic closed circuit composed of an upper yoke and a lower yoke formed of a magnetic metal, there are disposed a permanent magnet, a magnetic assembly including three central conductors disposed on a magnetic member (a ferrite member), and a resin case containing the magnetic assembly, matching capacitors, and external connection terminals such as input/output terminals and ground terminals therein. When the ports of the three central conductors are used as the input/output terminals, the nonreciprocal circuit device serves as a circulator. When a terminating resistor is connected to the port of one of the central conductors, the nonreciprocal circuit device serves as an isolator.

Conventionally, regarding electrical and mechanical connections between members constituting such a nonreciprocal circuit device, parts and surfaces for connecting the members to each other are connected to be bonded by solder. For example, when an upper yoke is connected to a lower yoke, the ports of the central conductors are connected to the input/output terminals or the hot-side electrodes of the capacitors, and the ground terminals are connected to the cold-side electrodes of the capacitors, paste solder is applied to parts connecting these constituting members and reflow soldering is performed in a high-temperature atmosphere.

Today, due to growing concern about environmental problems, there is a move afoot not to use lead in the process for manufacturing electronic components. As a result, solder that contains no lead and melts at approximately 220 degrees is now going into use in mounting of electronic components. When a nonreciprocal circuit device is mounted on a substrate by the solder whose melting point is approximately 220 degrees, the temperature of reflowing ranges from 240 to 260 degrees. In the conventional nonreciprocal circuit device in which parts are connected and bonded by solder, at the reflowing temperatures, the solder applied inside the device melts again. Consequently, connection and bonding between the parts become unstable. For example, the hot-side electrodes and cold-side electrodes of capacitors can be connected by the re-melting solder, thereby making both-side electrodes thereof short-circuited. In addition, there is a possibility that the connected parts are separated by the re-melting solder to cause connection failures due to open circuit. Furthermore, when the position of an upper yoke deviates from that of a lower yoke, a bias magnetic field applied to the magnetic assembly changes, thereby leading to deterioration of electrical characteristics.

Even though s high-temperature solder having the melting point of 220° C. or higher is used to connect parts in a nonreciprocal circuit device, when the reflowing temperature becomes higher, solder melting is inevitable. Thus, the above conventional nonreciprocal circuit device cannot maintain sufficiently reliable connections between the parts. In addition, from the recent no-lead-use tendency, there has been a strong demand for a nonreciprocal circuit device using no solder for connecting the parts thereof.

### SUMMARY OF THE INVENTION

Accordingly, it is an object of the present invention to provide a nonreciprocal circuit device having good characteristics capable of maintaining stable and reliable connections even at high temperatures. Additionally, it is another object of the present invention to provide a communication apparatus incorporating the nonreciprocal circuit device.

In order to accomplish the above objects, the present invention provides a nonreciprocal circuit device comprising a yoke containing a permanent magnet and a magnetic member including a plurality of central conductors, matching capacitors connected between the ports of one ends of the central conductors and grounds, and a ground connected to the remaining ends of the central conductors. In this nonreciprocal conductor, a conductive adhesive is applied to the members constituting the nonreciprocal circuit device to connect each other. In other words, at least one of the portions requiring electrical connections or all of them are connected by the conductive adhesive.

With the above arrangement, the members constituting the nonreciprocal circuit device are connected by the conductive adhesive. The conductive adhesive does not melt at high temperatures in a reflow soldering process for mounting. Thus, neither short circuit nor connection failures due to open circuit occur. In addition, positional deviations between an upper yoke and a lower yoke are reduced. As a result, fluctuations in a bias magnetic field due to the positional deviations between the yokes can be prevented. When the upper and lower yokes are connected by the conductive adhesive, as compared with connections by a resin adhesive which is not conductive, a more preferable magnetic circuit can be formed.

Furthermore, since the conductive adhesive is hardened at heat temperatures ranging from approximately 100 to 150° C., as compared with the conventional art using solder, heat stress applied when assembling the nonreciprocal circuit device is significantly reduced. As a result, deterioration of the characteristics due to the heat stress can be prevented.

Therefore, connection failures occurring when a high temperature is applied are significantly reduced, thereby increasing connection reliability, with the result that deterioration of the electrical characteristics can be prevented. Moreover, by using the conductive adhesive, the number of the parts connected by solder can be decreased or no solder is needed. Thus, a nonreciprocal circuit device including no lead can be obtained.

The conductive adhesive used may be the mixture of a resin adhesive and conductive metal powder. However, as a metal material included in the conductive adhesive, it is preferable to use one of silver and gold, each of which has a high conductivity and good electrical characteristics.

In order to reduce the positional deviations between the constituting members occurring due to softening of the resin adhesive due to high temperatures, a resin adhesive having good heat resistance may be used. For example, the resin adhesive may have heat-resistance temperatures of 200° C. or greater after hardening. Moreover, when a resin adhesive having heat-resistance temperatures of 240° C. or greater after hardening is used, even though a high temperature is applied in the reflow soldering process performed by solder including no lead, the positional deviations at connected parts can be prevented, with the result that more stable and reliable connections can be maintained.

In addition, the present invention provides a communication apparatus including the above nonreciprocal circuit device. With the nonreciprocal circuit device, a communication apparatus having highly reliable good characteristics can be obtained.

### BRIEF DESCRIPTION OF THE DRAWINGS

FIG. 1 is an exploded perspective view of an isolator according to a first embodiment of the present invention;

FIG. 2 is a plan view of the isolator in which an upper yoke and a permanent magnet are removed;

FIG. 3 is a plan view of the isolator showing positions at which a conductive adhesive is applied on a lower yoke;

FIG. 4 is a plan view of the isolator showing positions at which a conductive adhesive is applied in a resin case;

FIG. 5 is a plan view of the isolator showing positions at which a conductive adhesive is applied on capacitors and a terminating resistor;

FIG. 6 is a plan view of the isolator showing positions at which a conductive adhesive is applied on the upper-yoke side-wall surface; and

FIG. 7 is a block diagram of a communication apparatus according to a second embodiment of the present invention.

### DESCRIPTION OF THE PREFERRED EMBODIMENTS

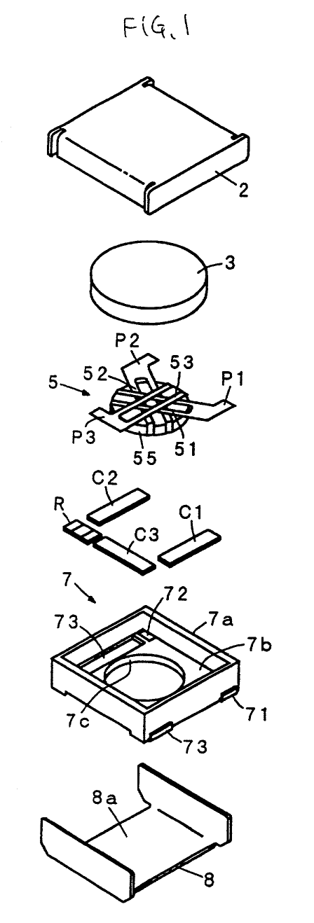

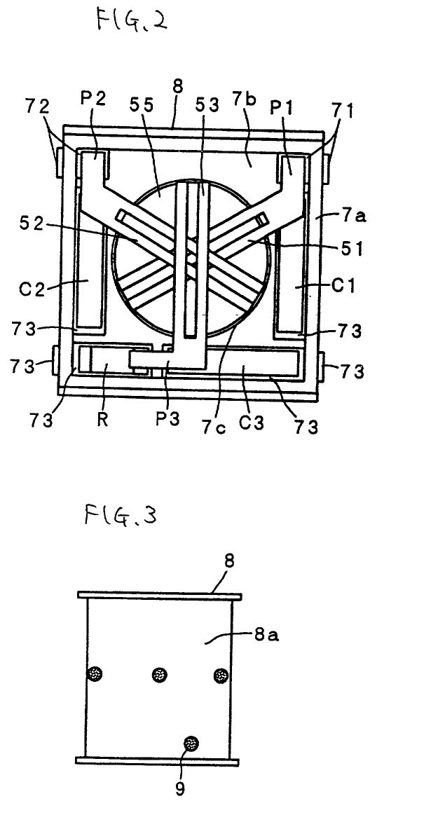

Referring to FIGS. 1 to 6, a description will be given of an isolator according to a first embodiment of the present invention. FIG. 1 shows an exploded perspective view of the isolator, FIG. 2 shows a plan view thereof in which an upper yoke and a permanent magnet are removed, and FIGS. 3 to 6 show plan views thereof, in which positions for applying a conductive adhesive to constituting members are shown.

As shown in FIGS. 1 and 2, in the isolator according to the first embodiment, a disk-shaped permanent magnet 3 is disposed on the inner surface of a box-shaped upper yoke 2 formed of a magnetic metal such as a soft iron. The upper yoke 2 and a substantially U-shaped lower yoke 8 formed of the same magnetic metal form a magnetic closed circuit. A resin case 7 is disposed on a bottom surface 8a inside the lower yoke 8. Inside the resin case 7, a magnetic assembly 5, matching capacitors C1, C2, and C3, and a terminating resistor R are disposed, in which a direct current magnetic field is applied to the magnetic assembly 5 by the permanent magnet 3. The upper yoke 2 and the lower yoke 8 serving as an external case are bonded with each other by a conductive adhesive to be electrically and mechanically connected to each other.

In the magnetic assembly 5, on the lower surface of the disk-shaped magnetic member 55, three central conductors 51 to 53 are in contact with a common ground portion. On the upper surface of the magnetic member 55, the three central conductors 51 to 53 are folded at angles of 120 degrees via an insulating sheet (not shown). Ports P1, P2, and P3 of the top portions of the central conductors 51 to 53 are outwardly protruded. The central conductors 51 to 53 are formed by punching out and processing a metal conductive plate such as a copper plate. The central conductors 51 to 53 have a circular ground portion as a common ground terminal of the central conductors, which are outwardly extended at predetermined angles (120 degrees) from the ground portion.

The resin case 7 is formed of a resin material having a heat resistance and insulative characteristics. The resin case 7 is formed by integrating a bottom wall 7b with a side wall 7a having a rectangular frame shape. Input/output terminals 71 and 72, and ground terminals 73 are disposed in a manner that parts of the terminals 71 to 73 are embedded in the resin material. An insertion hole 7c is formed substantially at the center of the bottom wall 7b to insert the magnetic assembly 5 therein. Outside the outer periphery of the insertion hole 7c of the bottom wall 7b, recesses for containing the three capacitors and a recess for containing the resistor are formed. In the recesses, the matching capacitor chips C1 to C3 and the terminating resistor chip R are disposed. The capacitors C1 to C3 are single-plate-type capacitors formed by electrodes disposed on the upper and lower surfaces of a dielectric substrate.

The input/output terminals 71 and 72 as external connection terminals and the ground terminals 73 are formed by punching out a metal conductive plate in predetermined forms to be folded. The intermediate parts of the terminals are insert-molded in the resin material to be embedded. The external connection part at one end of each terminal is exposed on the external surfaces of the bottom wall 7b and the side wall 7a. The remaining ends of the input/output terminals 71 and 72 are exposed on the inner surface of the bottom 7b. The remaining ends of the ground terminals 73 are exposed on the inner bottoms of the capacitor containing recesses and the resistor containing recess.

The common ground portion of the central conductors 51 to 53 on the lower surface of the magnetic assembly 5 is connected to the bottom 8a of the lower yoke 8 by a conductive adhesive 9. The ports P1 and P2 of the input/output-central conductors 51 and 52 are connected to the upper-surface electrodes (hot-side electrodes) of the capacitors C1 and C2 and parts exposed inside the bottom walls 7b of the input/output terminals 71 and 72 by the conductive adhesive 9. The port P3 of the central electrode 53 is connected to the upper surface electrode (hot-side electrode) of the capacitor C3 and the one-end side electrode (hot-side electrode) of the terminating resistor R by the conductive adhesive 9. The lower electrodes (cold-side electrodes) of the capacitors C1 to C3 and the remaining-end side electrode (cold-side electrode) of the terminating resistor R are connected to parts of the ground terminals 73 exposed on the inner bottom surface of the recesses for storing capacitors and the recess for storing resistor by the conductive adhesive 9.

The isolator is assembled as follows. First, as shown in FIG. 3, the conductive adhesive 9 is applied to four parts on the bottom wall 8a of the lower yoke 8. In FIG. 3, the conductive adhesive 9 positioned substantially at the center is connected to the common ground portion of the central conductors 51 to 53. The conductive adhesives 9 applied to the remaining three parts are connected to the ground terminals 73 on the lower surface of the resin case 7.

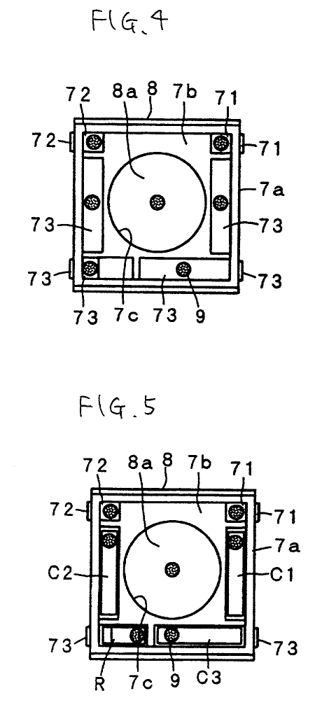

Next, as shown in FIG. 4, the resin case 7 is mounted on the lower yoke 8. Then, the conductive adhesive 9 is applied to each of the input/output terminals 71 and 72 exposed on the inner surface of the resin case 7, and the ground terminals 73 exposed on the inside parts of the capacitor containing recesses and the resistor containing recess. In FIG. 4, the conductive adhesives 9 applied on the input/output terminals 71 and 72 are connected to the ports P1 and P2 of the central conductors 51 and 52. The conductive adhesives 9 applied on the ground terminals 73 are connected to the cold-side electrodes of the capacitors C1 to C3 and the cold-side electrode of the terminating resistor R.

As shown in FIG. 5, the capacitors C1 to C3 are disposed in the capacitor containing recesses inside the resin case 7 and the terminating resistor R is disposed in the resistor containing recess. The conductive adhesives 9 are applied on the hot-side electrodes of the capacitors C1 to C3 and on the hot-side electrode of the terminating resistor R. In FIG. 5, the conductive adhesives 9 applied on the capacitors C1 to C3 are connected to the ports P1 to P3 of the central conductors 51 to 53. The conductive adhesive 9 applied on the terminating resistor R is connected to the port P3 of the central conductor 53.

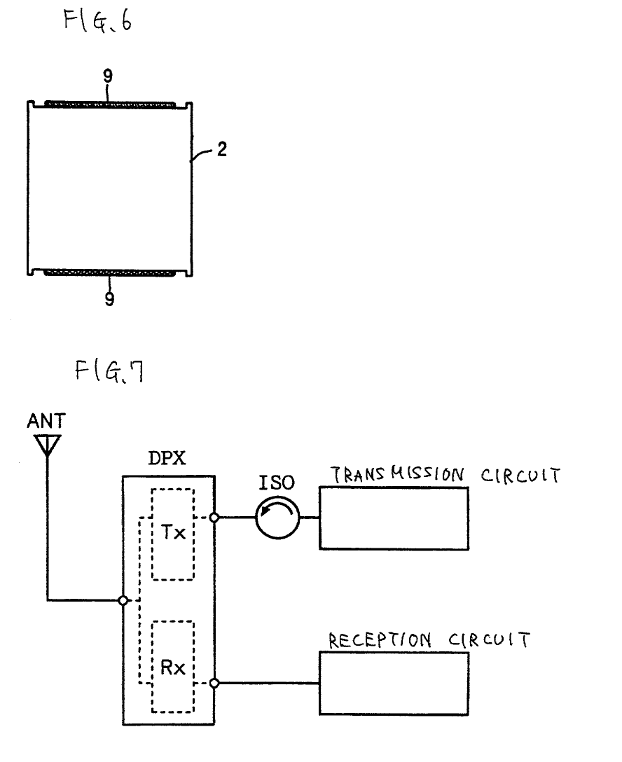

Next, the magnetic assembly 5 is disposed in the resin case 7, as shown in FIG. 2. Then, the permanent magnet 3 is arranged on the magnetic assembly 5, and as shown in FIG. 6, the conductive adhesives 9 are applied on the two side walls of the upper yoke 2. The side walls of the upper yoke 2, on which the conductive adhesives 9 are applied, are arranged such that the side walls thereof coincide with the side walls of the lower yoke 8.

The present invention is not restricted to the forms for applying the conductive adhesive 9, the number of parts to be applied, and the positions for applying the conductive adhesive 9, which are shown in FIGS. 3 to 6. For example, in FIG. 4, the conductive adhesives 9 may be applied to a plurality of parts of the capacitor containing recesses. The conductive adhesives 9 may be applied in band-like shape. In addition, opposite to those shown in FIGS. 3 to 6, the conductive adhesives 9 may be applied to the connected parts of counterpart members or may be applied on those of both members.

After the members are sequentially arranged as mentioned above, while applying pressure, the entire structure is heated at temperatures ranging from 100° C. to 150° C. for approximately 10 to 20 minutes in a batch furnace such as an oven or a belt-type furnace to harden the conductive adhesives 9.

When the members are arranged, assembly jigs are used. The conductive adhesives 9 are applied by a dispenser or the like. The conductive adhesive 9 is the mixture of an epoxy-resin adhesive having high heat resistance and Ag or Au metal powder with the weight ratio of 80% to 90%, in which the heat resistance temperature of the conductive adhesive 9 obtained after hardening is 250° C. (approximately 10 minutes) and 300° C. (approximately 30 seconds).

As the resin adhesive, other adhesives may be used such as acrylic resin, urethane resin, or silicone resin. The present invention adopts an epoxy-resin adhesive having great bonding strength and high heat resistance. In addition, the conductive material (metal powder) to be mixed is not restricted to Ag and Au. Other conductive materials such as Pt or Sn may be used. A plurality of these conductive materials may be mixed. The present invention uses Ag and Au, each of which has high conductivity and relatively stable electrical characteristics.

As described above, in the embodiment, the constituents are connected and bonded by the conductive adhesives 9 to be electrically and mechanically connected to each other. The conductive adhesives 9 do not melt again, unlike solder, even though a high temperature is applied in the reflow-soldering process for mounting. Thus, neither short circuit nor connection failures due to open circuit occur. In addition, positional deviations between the upper yoke and the lower yoke are reduced. Furthermore, since the conductive adhesive can be hardened at heat temperatures ranging from approximately 100 to 150 degrees, as compared with the conventional art using solder, heat stress applied when the assembly of the nonreciprocal circuit device is performed can be significantly reduced. As a result, deterioration of the characteristics due to the heat stress can be prevented. Moreover, since no solder is used, the nonreciprocal circuit device does not include lead.

In the structure of the above embodiment, when a circulator is obtained without connecting the port P3 to the terminating resistor R, the present invention can also be applied. In addition, although only the capacitors are connected as matching circuit elements in the above description, the present invention can also be applied in a nonreciprocal circuit device having a structure in which inductors and resistors or filter circuit elements are disposed in addition to matching capacitors. Thus, similarly, in these cases, each part in such a structure is connected by a conductive adhesive.

Furthermore, the structure of the nonreciprocal circuit device according to the invention is not restricted to the structure of the first embodiment. It is also possible to use a structure in which central conductors are formed of electrode films disposed inside of a dielectric member or a magnetic member or formed thereon.

Next, FIG. 7 shows the structure of a communication apparatus in accordance with a second embodiment of the present invention. In this communication apparatus, an antenna ANT is connected to the antenna terminal of a duplexer DPX composed of a transmission filter TX and a reception filter RX, an isolator ISO is connected between the input terminal of the transmission filter TX and a transmission circuit, and a reception circuit is connected to the output terminal of the reception filter RX. Signals transmitted from the transmission circuit pass through the isolator ISO and are transmitted to the antenna ANT via the transmission filter TX. Signals received in the antenna ANT is input to the reception circuit via the reception filter RX.

In this case, as the isolator ISO, the isolator of the above embodiment can be used. With the use of the nonreciprocal circuit device in accordance with the present invention, a highly reliable communication apparatus having satisfactory characteristics can be obtained.

As described above, in the nonreciprocal circuit device in accordance with the present invention, the constituting members are connected to each other by a conductive adhesive. Thus, since the conductive adhesive does not melt even though a high temperature is applied in the reflow-soldering process for mounting, neither short circuit nor connection failures due to open circuit occur. In addition, positional deviations between the upper yoke and the lower yoke can be reduced, and heat stress applied when assembling the nonreciprocal circuit device can be significantly reduced. Thus, connection failures can be significantly reduced, with the result that connection reliability can be improved and deterioration of the electrical characteristics can be prevented. Moreover, the nonreciprocal circuit device including no lead can be manufactured.

Furthermore, with the use of the nonreciprocal circuit device in accordance with the invention, a highly reliable commination apparatus having good characteristics can be obtained.

While the preferred embodiments of the present invention have been described, it is to be understood that modifications and variations will be apparent to those skilled in the art without departing from the spirit of the invention. The scope of the invention, therefore, is to be determined solely by the following claims.

What is claimed is:

1. A nonreciprocal circuit device comprising:
a yoke containing a permanent magnet, and a magnet member including a plurality of central conductors; and
capacitors connected between ports of the respective central conductors and grounds;
a ground connected to a ground portion of the respective central conductors;
wherein a conductive adhesive is applied to at least one of connection portions which connects the members comprising the nonreciprocal circuit device each other.

2. A nonreciprocal circuit device according to claim 1, wherein the yoke is formed by a plurality of yoke members, which are connected each other by the conductive adhesive.

3. A nonreciprocal circuit device according to claim 1, wherein the conductive adhesive is applied to connect the ports of the central conductors to the hot-side electrodes of the capacitors, the ground portion of the central electrodes to the yoke, the cold-side electrodes of the capacitors to ground terminals, and the ground terminals to the yoke.

4. A nonreciprocal circuit device a according to claim 1, wherein the ports of the central conductors are connected to input/output terminals corresponding thereto by the conductive adhesive.

5. A nonreciprocal circuit device according to claim 1, wherein the port of one of the plurality of central conductors is connected to a terminating resistor, the port of the central conductor is connected to the hot-side electrode of the terminating resistor, and the cold-side electrode of the terminating resistor is connected to a ground terminal by the conductive adhesive.

6. A nonreciprocal circuit device according to claim 1, wherein input/output terminals and ground terminals are embedded in a resin case, which contains the magnetic member, the central conductors, and the capacitors therein.

7. A nonreciprocal circuit device according to claim 1, wherein a conductive material included in the conductive adhesive is one of silver (Ag) and gold (Au).

8. A nonreciprocal circuit device according to claim 1, wherein the conductive adhesive has heat-resistance temperature of 200° C. or greater.

9. A communication apparatus comprising the reciprocal circuit device according to claim 1.
